(19) United States
(12) Patent Application Publication
(10) Pub. No.: US 2022/0379289 A1
(43) Pub. Date: Dec. 1, 2022

(54) QUANTUM-DOT LIGAND, QUANTUM-DOT CATALYST AND QUANTUM-DOT DEVICE

(71) Applicant: BOE Technology Group Co., Ltd., Beijing (CN)

(72) Inventor: Wenhai MEI, Beijing (CN)

(21) Appl. No.: 17/764,928

(22) PCT Filed: Jun. 17, 2021
(86) PCT No.: PCT/CN2021/100536

§ 371 Date: Mar. 29, 2022

(30) Foreign Application Priority Data
Jun. 19, 2020 (CN) 202010564353.X

(51) Int. Cl. B01J 31/18; B01J 31/22; B01J 35/00; C25B 1/04

(52) U.S. Cl. CPC B01J 31/183; B01J 31/22; B01J 35/004; C25B 1/04; B82Y 30/00

(57) ABSTRACT

The present disclosure provides a quantum-dot ligand, a quantum-dot catalyst and a quantum-dot device. The quantum-dot ligand includes: a first ligand having a first group and a second group and a second ligand having an inorganic ion, in which a coordination bond is formed between the first group and a surface of a quantum dot, a hydrogen bond is formed between the second group and a hydroxyl group; and a coordination bond is formed between the inorganic ion and the surface of the quantum dot. The quantum-dot catalyst of the present disclosure can enhance a catalytic activity of the quantum dots and improve the catalytic performance.

### CROSS-REFERENCE TO RELATED APPLICATION

This application claims a priority to Chinese Patent Application No. 202010564353.X filed on Jun. 19, 2020, the disclosures of which are incorporated in their entirety by reference herein.

### TECHNICAL FIELD

The present disclosure relates to the technical field of quantum dots, and in particular, the present disclosure relates to a quantum-dot ligand, a quantum-dot catalyst including the quantum-dot ligand, and a quantum-dot device including the quantum-dot catalyst.

### BACKGROUND

Quantum dot materials have become an emerging research hotspot in the field of photocatalysis technology due to the advantages of small size, large specific surface area, strong light responsiveness, unique electronic state and optical absorption properties, etc. However, the current quantum dot photocatalysis has shortcomings such as easy recombination of photogenerated carriers (i.e., holes and electrons) and low loading rate of quantum dots on the electrode surface. The extraction and transport of holes in photogenerated carriers is relatively slow, which easily leads to the recombination of photogenerated holes and photogenerated electrons before they reach the electrode surface. This results in low catalytic activity of quantum dots, thereby seriously restricting the application of quantum dot materials in the field of photocatalysis technology.

### SUMMARY

In a first aspect, an embodiment of the present disclosure provide a quantum-dot ligand, including: a first ligand having a first group and a second group, in which a coordination bond is formed between the first group and a surface of quantum dot, and a hydrogen bond is formed between the second group and a hydroxyl group; and a second ligand having an inorganic ion, in which a coordination bond is formed between the inorganic ion and the surface of the quantum dot.

Optionally, the first ligand has a general formula of R₁—R₂—R₃, in which R₁ has a first group, R₃ has a second group, and R₂ has at least one selected from a carbazole-based structure, a triphenylamine-based structure, or a fluorene-based structure.

Optionally, R₁ has a chemical formula of (CH₂)ₙR₄, 4≤n≤8, n is an integer, R₄ is the first group; and R₃ has a chemical formula of (CH₂)ₙR₅, 4≤n≤8, n is an integer, and R₅ is the second group.

Optionally, R₁ is a linear chain, one end of R₁ is connected to R₂, and the first group is located at the other end of R₁.

Optionally, R₃ is a linear chain, one end of R₃ is connected to R₂, and the second group is located at the other end of R₃.

Optionally, R₂ is

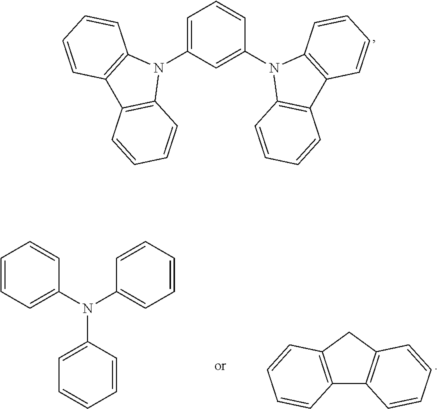

Optionally, the first group is at least one selected from thiol group, amino group or carboxyl group.

Optionally, the second group is at least one selected from amino group, hydroxyl group, carboxyl group, aldehyde group, carbonyl group or ether bond.

Optionally, the inorganic ion is at least one selected from O²⁻, S²⁻, Se²⁻, SCN⁻ or halide ion.

Optionally, the first ligand is:

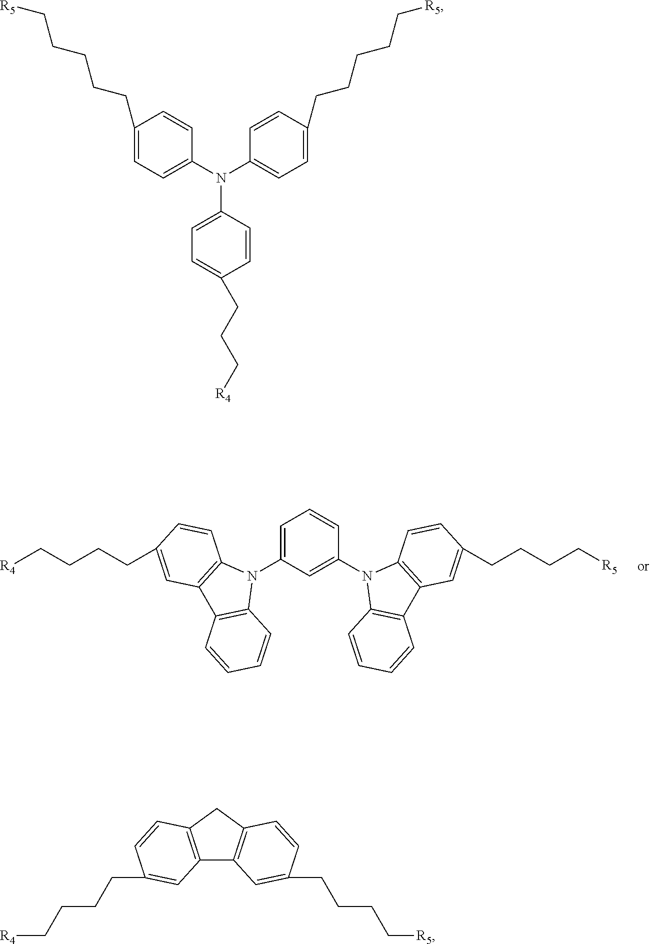

in which R₄ is independently —SH, —NH₂ or —COOH, and R₅ is independently —OH, —NH₂, —COOH, —CHO, —CO— or —O—.

In a second aspect, an embodiment of the present disclosure further provide a quantum-dot catalyst, including quantum dots and the quantum-dot ligand described in any one of the above embodiments, in which a coordination bond is formed between the first group in the first ligand and a surface of the quantum dot, and a coordination bond is formed between the inorganic ion and the surface of the quantum dot.

In a third aspect, an embodiment of the present disclosure further provides a quantum-dot device, including the quantum-dot catalyst described in any one of the above embodiments.

Optionally, the quantum-dot device further includes a positive electrode and a negative electrode, and the quantum-dot catalyst is located between the positive electrode and the negative electrode and is arranged as a layer.

Optionally, surfaces of the positive electrode and the negative electrode have hydroxyl groups, and hydrogen bonds are formed between the second group in the quantum-dot catalyst and the hydroxyl groups on the surfaces of the positive electrode and the negative electrode, respectively.

Optionally, the quantum-dot catalyst is arranged as a single layer of quantum dots or a multilayer of quantum dots.

The technical solutions according to the embodiments of the present disclosure have the following advantageous technical effects.

When the quantum-dot ligand according to the embodiment of the present disclosure is combined with the quantum dots, a coordination bond is formed between the first group and the surface of the quantum dot, hydrogen bond is formed between the second group and a hydroxyl group, and a coordination bond is formed between the inorganic ion and the surfaces of the quantum dots. By forming hydrogen bonds between the second group and the hydroxyl groups on the surface of the electrode, the second group can generate a strong interaction force with the hydroxyl groups to load the quantum dots on the surface of the electrode, thereby improving the loading rate of the quantum dots on the surfaces of the electrodes. The introduction of inorganic ions on the surfaces of the quantum dots is beneficial to reduce the potential barrier for holes to be extracted and separated from the quantum dots, thereby facilitating the separation and extraction of holes and electrons in photogenerated carriers, and is beneficial to hole transport. The quantum-dot catalysts of the embodiments of the present disclosure can enhance the catalytic activity of the quantum dots and improve the catalytic performance.

### BRIEF DESCRIPTION OF THE DRAWINGS

FIG. 1 is a schematic view showing a binding between a ligand and quantum dots according to an embodiment of the present disclosure.

FIG. 2 is a schematic view showing quantum dots of a quantum-dot ligand loaded on a surface of an electrode according to embodiments of the present disclosure.

FIG. 3 is a schematic view showing a quantum-dot device in a container according to an embodiment of the present disclosure.

FIG. 4 is a schematic view showing generation of hydrogen gas on the surface of an electrode under the action of a quantum-dot catalyst according to an embodiment of the present disclosure.

### DETAILED DESCRIPTION

In order to make the objectives, the technical solutions, and the advantages of the examples of the present disclosure, the technical solutions in the embodiments of the present disclosure will be described clearly and completely hereinafter in conjunction with the drawings. Obviously, the following embodiments relate to a part of, rather than all of, the embodiments of the present disclosure. Based on following embodiments, a person skilled in the art may obtain the other embodiments, which also fall within the scope of the present disclosure.

Photocatalytic hydrogen production technology can convert solar energy into hydrogen energy, which is an effective way to fundamentally solve the energy crisis and environmental problems, so it has been widely concerned. However, the low photocatalytic efficiency limits the application prospects of photocatalytic hydrogen production technology. How to obtain high-performance and low-cost semiconductor photocatalytic materials has become a key issue in the development of photocatalytic technology. Quantum dot materials have become an emerging research hotspot in the field of photocatalysis technology due to the advantages of small size, large specific surface area, strong light responsiveness, unique electronic state and optical absorption properties, etc. In addition, cadmium selenide (CdSe) semiconductor photocatalytic materials possess suitable band gaps, unique crystal structure features, and exhibit excellent photocatalytic performance under visible light. However, the current quantum dots such as CdSe have disadvantages such as easy recombination of photogenerated carriers and low loading rate on the electrode surface. This results in the low catalytic activity of quantum dots, thereby severely restricting their application in the field of catalysis. How to improve the catalytic performance of quantum dots based on semiconductor materials such as cadmium selenide is an urgent problem to be solved.

In view of this, the present disclosure provides a quantum-dot ligand, a quantum-dot catalyst and a quantum-dot device, to solve the problems, such as low loading rate of quantum dots on the electrode surface, easy recombination of photogenerated charges, and slow extraction and transport of holes in photogenerated carriers, thereby improving the catalytic activity of quantum-dot catalysts.

In one aspect, the present disclosure provides a quantum-dot ligand, including a first ligand and a second ligand, in which the first ligand has a first group and a second group, a coordination bond can be formed between the first group and a surfaces of a quantum dot, and hydrogen bond can be formed between the second group and a hydroxyl group; in which the second ligand has inorganic ions, and a coordination bond can be formed between the inorganic ions and the surface of the quantum dot.

Specifically, hydrogen bonds can be formed between the second group and the hydroxyl groups on the surfaces of the electrodes, strong interaction force can be generated between the second group and the hydroxyl groups; and a coordination bond can be formed between inorganic ions in the second ligand and the surfaces of quantum dots such as CdSe. When the quantum-dot ligand according to the embodiment of the present disclosure is combined with the quantum dots such as CdSe, a coordination bond is formed between the first group and the surface of the quantum dot, hydrogen bond is formed between the second group and a hydroxyl group, and a coordination bond is formed between the inorganic ion and the surface of the quantum dot. By forming hydrogen bond between the second group and the hydroxyl groups on the surfaces of the electrode, the second group can generate a strong interaction force with the hydroxyl group to firmly load the quantum dots on the surfaces of the electrodes, thereby improving the loading rate of the quantum dots on the surfaces of the electrodes. The introduction of inorganic ions on the surfaces of the quantum dots is beneficial to reduce the potential barrier for holes to be extracted and separated from the quantum dots. The introduction of inorganic ions on the surfaces of quantum dots can be more beneficial to the separation and extraction of holes and electrons in photogenerated carriers, and is beneficial to hole transport, thereby avoiding secondary recombination of holes and electrons. The quantum dots containing the quantum-dot ligands of the present disclosure can be used as catalysts, to enhance the catalytic activity of the quantum dots and improve the catalytic performance.

In some embodiments of the present disclosure, the general formula of the first ligand may be R₁—R₂—R₃, in which R₁ has a first group, R₃ has a second group, and R₂ has at least one selected from a carbazole-based structure, a triphenylamine-based structure, or a fluorene-based structure.

For example, R₂ can be a carbazole-based structure, and an exemplary structural formula of R₂ can be:

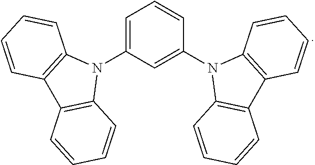 [SMILES: c1cc(-n2c3ccccc3c3ccccc32)cc(-n2c3ccccc3c3ccccc32)c1]

For example, R₂ can be a triphenylamine-based structure, and an exemplary structural formula of R₂ can be:

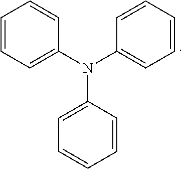 [SMILES: c1ccc(N(c2ccccc2)c2ccccc2)cc1]

For example, R₂ can be a fluorene-based structure, and an exemplary structural formula of R₂ can be:

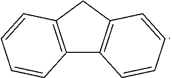 [SMILES: c1ccc2c(c1)Cc1ccccc1-2]

The introduction of a carbazole-based structure, a triphenylamine-based structure or a fluorene-based structure into the ligands of the quantum dots is more beneficial to hole transport, that is, the ligands can quickly transfer the separated and extracted holes to the electrode for reduction reaction. Therefore, such ligands can enhance the catalytic activity of quantum dots and improve the catalytic performance.

In some embodiments of the present disclosure, the chemical formula of R₁ has a chemical formula of (CH₂)ₙR₄, 4≤n≤8, n is an integer, R₄ is the first group; and/or R₃ has a chemical formula of (CH₂)ₙR₅, 4≤n≤8, n is an integer, and R₅ is the second group. The carbon chains in R₁ and R₃ cannot be too long (no more than 8 carbon atoms), which is beneficial to the separation and extraction of holes and electrons in photogenerated carriers, and is beneficial to hole transport. Furthermore, the ligand can enhance the catalytic activity of the quantum dots and improve the catalytic performance.

In some embodiments of the present disclosure, R₁ is a linear chain, one end of R₁ is connected to R₂, and the first group is located at the other end of R₁. The ligand facilitates the formation of a coordination bond between the first group and the surfaces of the quantum dots. In some embodiments of the present disclosure, R₃ is a linear chain, one end of R₃ is connected to R₂, and the second group is located at the other end of R₃. The ligand facilitates the formation of hydrogen bond between the second group and hydroxyl groups on the surfaces of the electrodes, so that a strong interaction force is generated between the second group and the hydroxyl groups. This improves the loading rate of quantum dots on the surface of the electrodes.

In some embodiments of the present disclosure, R₁ in the first ligand may contain 4 to 8 carbon atoms and have a group such as —SH, —NH₂ or —COOH at an end away from R₂; and R₃ may contain 4 to 8 carbon atoms and have a group such as —OH, —NH₂, —COOH, —CHO, —CO— or —O— at an end away from R₂.

Optionally, the first group may include at least one of thiol group, amino group or carboxyl group. For example, the first group can be —SH, —NH₂ or —COOH. The ligand facilitates the formation of a coordination bond between the first group and the surface of the quantum dots.

Optionally, the second group may include at least one selected from amino group, hydroxyl group, carboxyl group, aldehyde group, carbonyl group or ether bond. For example, the second group can be —NH₂, —OH, —COOH, —CHO, —CO— or —O—, and the like. This facilitates the formation of hydrogen bond between the second group and a hydroxyl group, so that a strong interaction force is generated between the second group and the hydroxyl group. For example, as shown in FIG. 2, the second group is hydroxyl group (—OH), and hydrogen bond is formed between the hydroxyl group and hydroxyl groups on the surfaces of the electrodes, so as to firmly load the quantum dots 10 on the surfaces of the electrodes, thereby improving the loading rate of quantum dots on the surface of the electrodes.

In some embodiments of the present disclosure, the inorganic ions may include at least one of O²⁻, S²⁻, Se²⁻, SCN⁻, or halide ions. For example, the halide ion can be F⁻, Cl⁻, Br⁻ OR I⁻. The introduction of the above inorganic ions can be more beneficial to the separation and extraction of holes and electrons in photogenerated carriers, and is also beneficial to hole transport.

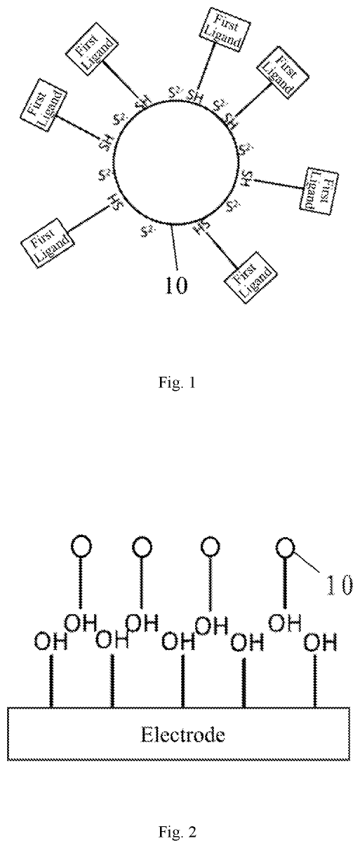

In some embodiments of the present disclosure, as shown in FIG. 1, the first group includes a sulfhydryl group (—SH), the inorganic ion is S²⁻, a coordination bond is formed between the sulfhydryl group of the first group and the surface of the quantum dot 10, and a coordination bond is formed between the inorganic ion S²⁻ and the surface of the quantum dot 10, so as to introduce S²⁻ on the surface of the quantum dot.

In some embodiments of the present disclosure, the structural formula of the first ligand may be:

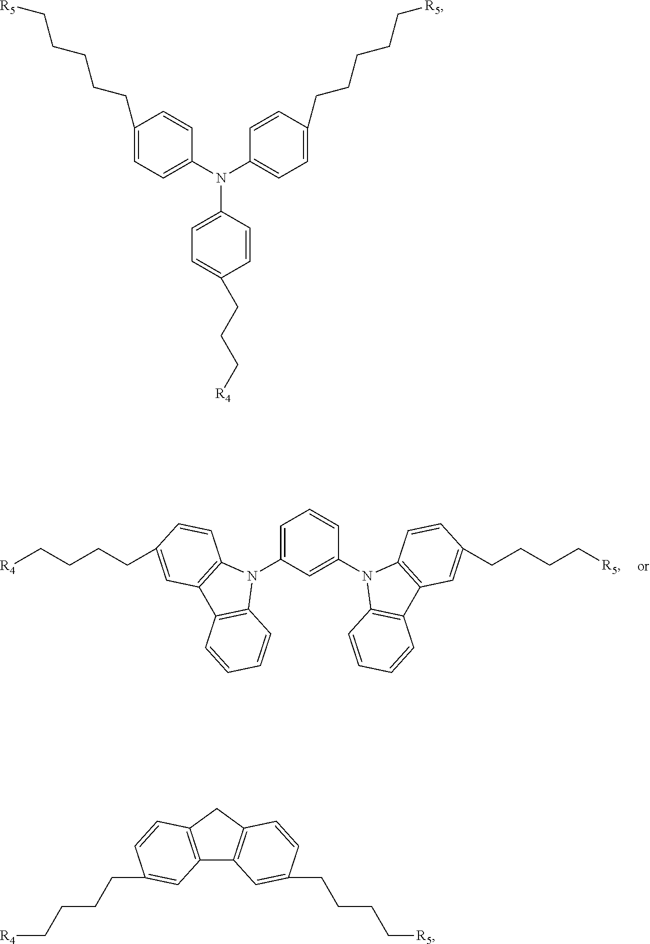

in which R₄ can be —SH, —NH₂ or —COOH, and R₅ can be —OH, —NH₂, —COOH, —CHO, —CO— or —O—.

For example, the structural formula of the first ligand A can be:

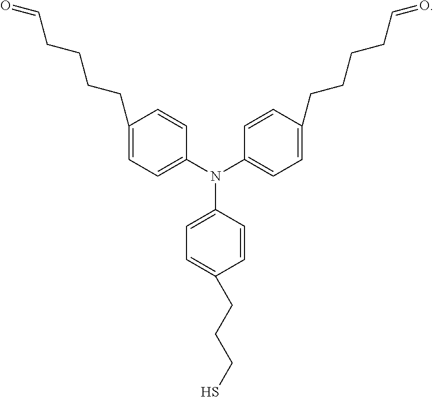 [SMILES: O=CCCCCc1ccc(N(c2ccc(CCCS)cc2)c2ccc(CCCCC=O)cc2)cc1]

A coordination bond can be formed between —SH in the first ligand A and the surface of the quantum dot, and hydrogen bonds can be formed between —CO— and the hydroxyl groups on the surface of the electrodes, so as to load the quantum dots on the surfaces of the electrodes.

In the process of preparing the quantum-dot ligand of the present disclosure, CdS/CdSe quantum dots could be selected as the quantum dots, and the original ligand is oleic acid. CdS/CdSe quantum dots were prepared by traditional hydrothermal method. After the preparation, ligand exchange was performed in a stratified solution of hexane and DMF (dimethylformamide). Specifically, 500 mg of the first ligand A was added to 100 mg of quantum dot, and after stirring for half an hour at room temperature, the quantum dots would be transferred to the DMF phase due to ligand exchange. The DMF phase was separated from the hexane phase, and methanol was added for precipitation. After centrifugation, the quantum dots were dissolved in DMF. The quantum dots were washed twice, thereby obtaining quantum dots whose ligand was the first ligand A. After dissolving the quantum dots whose ligand was the first ligand A in DMF, 200 mg of sodium sulfide was added, and after stirring at room temperature for half an hour, methanol was added for precipitation. After centrifugation, the quantum dots were dissolved in DMF. The quantum dots were washed twice, thereby obtaining quantum dots whose ligand is a mixture of the first ligand A and S²⁻. In addition, the ligands in the embodiments of the present disclosure may also be bound to the quantum dots by other existing methods, which will not be repeated herein.

In a second aspect, the present disclosure further provides a quantum-dot catalyst, including: a quantum dot and the quantum-dot ligand according to any one of the above embodiments. The quantum dots may be CdSe quantum dots. A coordination bond was formed between the first group in the first ligand and a surface of the quantum dot, and a coordination bond was formed between the inorganic ion and the surface of the quantum dot.

In the quantum-dot catalyst of the present disclosure, hydrogen bonds were formed between the second group in the first ligand and the hydroxyl groups on the surfaces of the electrodes, and a strong interaction force was generated between the second group and the hydroxyl groups to load the quantum dots on the surfaces of the electrodes, thereby improving the loading rate of quantum dots on the surface of the electrodes. The introduction of inorganic ions on the surfaces of the quantum dots could reduce the potential barrier for holes to be extracted and separated from the quantum dots, which was more beneficial to the separation and extraction of holes and electrons in photogenerated carriers, and was beneficial to hole transport. This avoided the secondary recombination of holes and electrons and improved the catalytic activity of the quantum dots.

In a third aspect, the present disclosure further provides a quantum-dot device, including: the quantum-dot catalyst described in any one of the above embodiments.

In the quantum-dot device of the present disclosure, the quantum-dot catalyst could improve the loading rate of the quantum dots, and could enhance the catalytic activity of the quantum dots, and improve the catalytic performance.

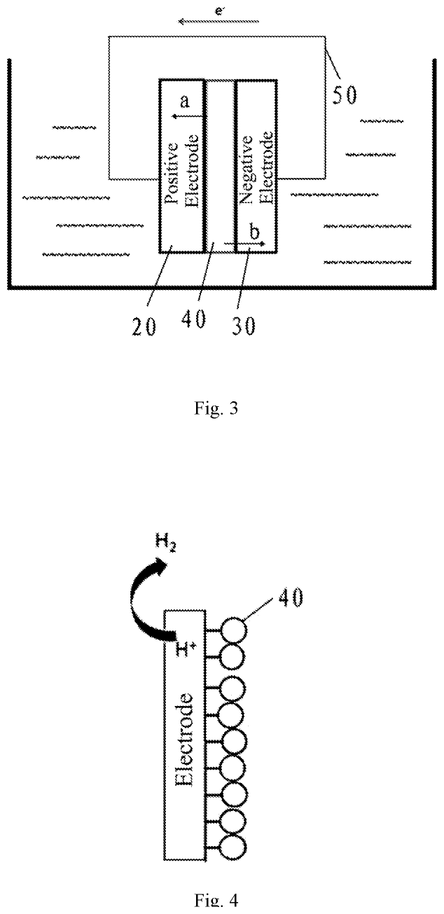

In the embodiment of the present disclosure, as shown in FIG. 3, the quantum-dot device may further include a positive electrode 20 and a negative electrode 30, the surfaces of the positive electrode 20 and the negative electrode 30 had hydroxyl groups, the quantum-dot catalyst 40 was a layered quantum dot array (which could be a single-layer or multi-layer quantum dot arrangement), the positive electrode 20 was located on one end of the quantum-dot catalyst 40, and the negative electrode 30 was located on the other end of the quantum-dot catalyst 40, and the positive electrode 20 and the negative electrode 30 were electrically connected. For example, the positive electrode 20 and the negative electrode 30 may be electrically connected by a conductive wire 50. Hydrogen bonds were formed between the second group in the quantum-dot catalyst and the hydroxyl groups on the surfaces of the positive electrode 20 and the negative electrode 30, respectively, so as to load the quantum dots in the quantum-dot catalyst 40 on the surfaces of the positive electrode 20 and the negative electrode 30.

For example, water could be electrolyzed by the quantum-dot device of the present disclosure. As shown in FIG. 3, the quantum-dot device could be placed in a container containing water. A light source that emitted visible light may be positioned adjacent to the container. Under the action of the quantum-dot catalyst 40, the quantum dots according to the embodiments of the present disclosure absorbed visible light, to generate photogenerated carriers. The carriers were separated into photogenerated holes a and electrons b by the force of the electric field. The transport directions of holes a and electrons b may be directions shown by arrows in FIG. 3. The holes a were rapidly transferred to the electrode for the reduction reaction, as shown in FIG. 4, thereby generating hydrogen (H₂) on the electrode surface. In the quantum-dot device of the present disclosure, a hydrogen bond was formed between the second group and the hydroxyl group on the surfaces of the electrodes, and a strong interaction force was generated between the second group and the hydroxyl groups to load the quantum dots on the surfaces of the electrodes, thereby improving the loading rate of quantum dots on the surfaces of the electrodes. The introduction of inorganic ions on the surfaces of the quantum dots was beneficial to reduce the potential barrier for holes to be extracted and separated from the quantum dots, and the introduction of inorganic ions was beneficial to the separation and extraction of holes and electrons in photogenerated carriers, and is beneficial to hole transport, thereby avoiding secondary recombination of holes and electrons. Therefore, the quantum-dot device of the present disclosure could enhance the catalytic activity of the quantum dots, improve the catalytic performance, and thus the production efficiency of electrolyzed water was high.

Unless otherwise defined, technical terms or scientific terms used herein have the normal meaning commonly understood by one skilled in the art in the field of the present disclosure. The words “first”, “second”, and the like used herein does not denote any order, quantity, or importance, but rather merely serves to distinguish different components. The word “connected” or “connecting” and the like are not limited to physical or mechanical connections, but may include electrical connections, whether direct or indirect. “On”, “under”, “left”, “right” and the like are only used to represent relative positional relationships, and when the absolute position of the described object is changed, the relative positional relationship may also be changed, accordingly.

The above description is the optional embodiment of the present disclosure. It should be noted that one skilled in the art would make several improvements and substitutions without departing from the principles of the present disclosure. These improvements and modifications should also be regarded as the protection scope of the present disclosure.

1. A quantum-dot ligand, comprising:
a first ligand having a first group and a second group, wherein a coordination bond is formed between the first group and a surface of a quantum dot, and a hydrogen bond is formed between the second group and a hydroxyl group; and
a second ligand having an inorganic ion, wherein a coordination bond is formed between the inorganic ion and the surface of the quantum dot.

2. The quantum-dot ligand of claim 1, wherein the first ligand has a general formula of R₁—R₂—R₃, wherein R₁ has the first group, R₃ has the second group, and R₂ has at least one selected from a carbazole-based structure, a triphenylamine-based structure, or a fluorene-based structure.

3. The quantum-dot ligand of claim 2, wherein R₁ has a chemical formula of (CH₂)ₙR₄, 4≤n≤8, n is an integer, R₄ is the first group; and
wherein R₃ has a chemical formula of (CH₂)ₙR₅, 4≤n≤8, n is an integer, and R₅ is the second group.

4. The quantum-dot ligand of claim 2, wherein R₁ is a linear chain, one end of R₁ is connected to R₂, and the first group is located at the other end of R₁.

5. The quantum-dot ligand of claim 2, wherein R₃ is a linear chain, one end of R₃ is connected to R₂, and the second group is located at the other end of R₃.

6. The quantum-dot ligand of claim 2, wherein R₂ is:

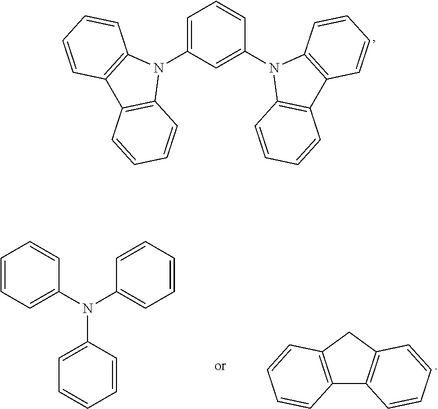

7. The quantum-dot ligand of claim 1, wherein the first group is at least one selected from thiol group, amino group or carboxyl group.

8. The quantum-dot ligand of claim 1, wherein the second group is at least one selected from amino group, hydroxyl group, carboxyl group, aldehyde group, carbonyl group or ether bond.

9. The quantum-dot ligand of claim 1, wherein the inorganic ion is at least one selected from O²⁻, S²⁻, Se²⁻, SCN ⁻ or halide ion.

10. The quantum-dot ligand of claim 1, wherein the first ligand is: 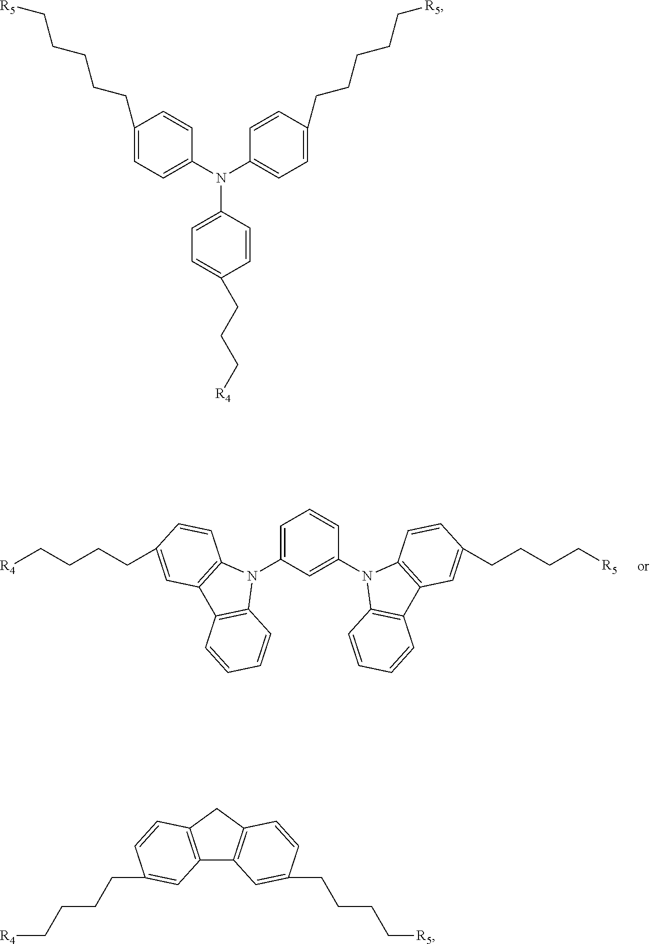
wherein R₄ is independently —SH, —NH₂ or —COOH, and R₅ is independently —OH, —NH₂, —COOH, —CHO, —CO— or —O—.

11. A quantum-dot catalyst, comprising:
a quantum dot; and
the quantum-dot ligand of claims 1,
wherein a coordination bond is formed between the first group in the first ligand and a surface of the quantum dot, and a coordination bond is formed between the inorganic ion and the surface of the quantum dot.

12. A quantum-dot device, comprising the quantum-dot catalyst of claim 11.

13. The quantum-dot device of claim 12, wherein the quantum-dot device further comprises a positive electrode and a negative electrode, and the quantum-dot catalyst is located between the positive electrode and the negative electrode and is arranged as a layer.

14. The quantum-dot device of claim 13, wherein surfaces of the positive electrode and the negative electrode have hydroxyl groups, and hydrogen bonds are formed between the second group in the quantum-dot catalyst and the hydroxyl groups on the surfaces of the positive electrode and the negative electrode, respectively.

15. The quantum-dot device of claim 13, wherein the quantum-dot catalyst is arranged as a single layer of quantum dots or a multilayer of quantum dots.

16. The quantum-dot catalyst of claim 11, wherein the first ligand has a general formula of R₁—R₂—R₃, wherein R₁ has the first group, R₃ has the second group, and R₂ has at least one selected from a carbazole-based structure, a triphenylamine-based structure, or a fluorene-based structure.

17. The quantum-dot catalyst of claim 16, wherein R₁ has a chemical formula of (CH₂)ₙR₄, 4≤n≤8, n is an integer, R₄ is the first group; and
wherein R₃ has a chemical formula of (CH₂)ₙR₅, 4≤n≤8, n is an integer, and R₅ is the second group.

18. The quantum-dot catalyst of claim 16, wherein R₁ is a linear chain, one end of R₁ is connected to R₂, and the first group is located at the other end of R₁.

19. The quantum-dot catalyst of claim 16, wherein R₃ is a linear chain, one end of R₃ is connected to R₂, and the second group is located at the other end of R₃.

20. The quantum-dot catalyst of claim 16, wherein R₂ is: [chemical structure]
